(19) United States
(12) Patent Application Publication
(10) Pub. No.: US 2008/0283618 A1
(43) Pub. Date: Nov. 20, 2008

(54) Contactless Transmission System and Method for Producing the Same

(75) Inventors: Frank PUESCHNER, Kelheim (DE); Stephan Franz JANKA, Regensburg (DE)

Correspondence Address: INFINEON TECHNOLOGIES AG;Patent Department, MUC 11.1.507, P.O. Box 221644, Munich, 80506, DE

(73) Assignee: INFINEON TECHNOLOGIES AG, Neubiberg (DE)

(21) Appl. No.: 12/120,268

(22) Filed: May 14, 2008

(30) Foreign Application Priority Data
May 15, 2007 (DE) 10 2007 022 615.4

(51) Int. Cl. G06K 19/067

(52) U.S. Cl. 235/492

(57) ABSTRACT

A contactless transmission system comprises a carrier substrate, an antenna on the carrier substrate, a semiconductor chip and a connecting means on the carrier substrate. In this case, the antenna and the semiconductor chip are fitted to the connecting means such that an electric current flow can take place between the antenna and the semiconductor chip.

### RELATED APPLICATION

The present application claims priority to German Application No. 10 2007 022 615 filed May 15, 2007, which is incorporated by reference herein in its entirety.

### BACKGROUND

Contactless transponders are microelectronic arrangements containing a semiconductor chip and an antenna. Exemplary applications are contactless smart cards, merchandise and merchandise packagings with an incorporated antenna and transponder chip, electronic contactless labels, tickets, notes of value and for some time also electronic identification cards.

During operation, the energy required for operating the semiconductor chip is transmitted in the most general form by means of electromagnetic waves from a terminal to the transponder. The data traffic between the terminal and the semiconductor chip is also effected in this way. For this purpose, antennas which transmit and receive the electromagnetic waves are provided, both in the terminal and in the transponder.

Since transponder units are generally produced separately to the actual end product, such as e.g. an electronic passport, the transponder unit comprising semiconductor chip and antenna is arranged on a carrier element, which together form a so-called card inlay. This card inlay is integrated by the passport manufacturer, for example, in the passport in such a way that it is surrounded by the actual parts of the passport.

### BRIEF DESCRIPTION OF THE DRAWINGS

FIG. 1 shows a schematic plan view of an excerpt from a card inlay.

FIG. 2 shows a schematic cross-sectional view of the card inlay from FIG. 1 along section A-A′.

FIG. 3 shows a schematic plan view of an excerpt from a card inlay with a chip module.

FIG. 4 shows a schematic cross-sectional view of the card inlay from FIG. 3 along section B-B′.

FIG. 5 shows a schematic cross-sectional view of a variant of a card inlay with chip.

FIG. 6 shows a schematic cross-sectional view of a further variant of a card inlay with chip module.

FIG. 7 shows a schematic cross-sectional view of a further variant of a card inlay with chip module.

### DETAILED DESCRIPTION

One aspect of the invention relates to a contactless transmission system, in particular a transponder, with a carrier substrate, a coil antenna, a semiconductor chip and two electrically conductive connecting elements.

Before the exemplary embodiments are explained in more detail below with reference to the figures, it is pointed out that identical elements in the figures are provided with the same or similar reference symbols, and that a repeated description of said elements is omitted.

However, the invention is not restricted to the embodiments described in concrete fashion, but rather can be modified and amended in a suitable manner. It lies within the scope of the invention to combine individual features and feature combinations of one embodiment with features and feature combinations of another embodiment in a suitable manner in order to attain further embodiments according to the invention.

In all the embodiments that are described herein, the term semiconductor chip should be understood to mean a simple chip, which is possibly also housed, and a chip module.

Embodiments relate generally to a contactless transmission system comprising a carrier substrate, an antenna on the carrier substrate, a semiconductor chip and a connecting means on the carrier substrate, wherein the antenna and the semiconductor chip are fitted to the connecting means such that an electric current flow can take place between the antenna and the semiconductor chip.

One embodiment specifically relates to a contactless transponder, comprising a carrier substrate, a coil antenna having two coil end sections, a semiconductor chip having two antenna connections, and two electrically conductive connecting elements, which are arranged in a manner electrically insulated from one another on the carrier substrate, wherein the coil antenna is produced on the carrier substrate and one coil end section is at least partly produced on the first connecting element and electrically connected thereto and the other coil end section is at least partly produced on the second connecting element and electrically connected thereto, and wherein the first antenna connection of the semiconductor chip is fitted to the first connecting element and electrically connected thereto and the second antenna connection of the semiconductor chip is fitted to the second connecting element and electrically connected thereto.

By virtue of this arrangement, the connection between semiconductor chip and coil antenna can be reliably produced by means of the connecting element. In a separate step, the coil antenna can be produced on the carrier substrate and be contact-connected to the connecting element. The mounting of the semiconductor chip can then be fitted to the connecting element in a later step using conventional flip-chip contact-connecting techniques, thus giving rise to an electrical connection between antenna and semiconductor chip.

Furthermore, embodiments relate generally to a method for producing a contactless transmission system, wherein a carrier substrate is provided, a connecting means is fitted on the carrier substrate, an antenna is produced on the carrier substrate and the antenna is fitted on the connecting means and a semiconductor chip is fitted to the connecting means.

One embodiment relates specifically to a method for producing a contactless transponder, wherein a carrier substrate is provided, two electrically conductive connecting elements are arranged in a manner electrically insulated from one another on the carrier substrate, at least one part of a first coil end section is produced on the first connecting element and an electrical connection is produced between the first coil end section and the first connecting element, a coil antenna is produced on the carrier substrate, at least one part of a second coil end section is produced on the second connecting element and an electrical connection is produced between the second coil end section and the second connecting element, a first antenna connection of a semiconductor chip is fitted to the first connecting element and a second antenna connection of the semiconductor chip is fitted to the second connecting element in such a way that an electrical connection is in each case produced between the semiconductor chip and the connecting element.

By virtue of a connecting means being provided, it is possible for the antenna and the semiconductor chip to be produced separately and only later joined together to form a finished card inlay.

FIG. 1 shows a contactless transmission system (transponder) 10 with a carrier substrate 11, an antenna 12, a semiconductor chip 13 and a connecting means 14.

The carrier substrate 11 is, in particular, a substrate composed of thermoplastic material or paper.

The antenna 12 is fitted on the carrier substrate 11. The antenna 12 is typically formed as a coil antenna and has two coil end sections 22, 22′ in this case. In particular, the coil antenna 12 having the two coil end sections 22, 22′ is formed from a wire. In this case, the wire is laid in coil-type fashion on the carrier substrate 11. For mechanical stabilization, the wire in this case can be at least partly connected mechanically to the carrier substrate 11. This is done by means of an ultrasonic laying head, for example, which presses the wire into the carrier substrate 11 at least at points by virtue of the carrier substrate 11 being melted at points with the aid of the ultrasonic laying head and the wire being pressed into this melt. The wire is generally pressed into the carrier substrate 11 virtually over its entire length by the method described.

As an alternative, the antenna 12, in particular the coil antenna, can also be produced on the carrier substrate 11 by virtue of the antenna 12 being printed on, electrodeposited or produced from a combination of printing and electrodeposition.

The connecting means 14 is arranged on the carrier substrate 11 and includes for example two connecting elements 14′, 14″ that are electrically insulated from one another but are inherently electrically conductive.

The connecting means 14 can likewise be produced by printing, electrodeposition or a combination of the two. As an alternative, the connecting means 14 can be a prefabricated metallic element, for example a stamped part, which is connected to the carrier substrate 11 in force-locking fashion.

The antenna 12 is fitted to said connecting means 14. Using the example of the coil antenna and the two connecting elements 14′, 14″, this is done by fitting at least one part of the first coil end section 22 on the first connecting element 14′ and by fitting at least one part of the second coil end section 22′ on the second connecting element 14″. For this purpose, by way of example, parts of the coil end sections 22, 22′ are produced directly on the connecting elements 14′, 14″ by virtue of the wire being placed on the connecting elements 14′, 14″ or the coil end sections 22, 22′ being printed or electrodeposited on the connecting elements 14′, 14″ or being produced thereon using a combination of printing and electrodeposition. An electrical connection is produced between the antenna 12 and the connecting means 14.

The semiconductor chip 13 is likewise fitted to the connecting means 14 and an electrical contact is produced between semiconductor chip 13 and connecting means 14. For this purpose, in particular, a first antenna connection (not illustrated) at the surface of the semiconductor chip 13 is for example fitted and electrically contact-connected to the first connecting element 14′ and a second antenna connection (not illustrated) at the surface of the semiconductor chip 13 is fitted and electrically contact-connected to the second connecting element 14″. The semiconductor chip 13 is fitted using flip-chip technology. In this case, the antenna connections of the semiconductor chip are fitted directly to the connecting element in a customary form for flip-chip technology, by a procedure in which e.g. the antenna connections are pressed into the connecting elements 14′, 14″ and the semiconductor chip 13 is additionally adhesively bonded to the carrier substrate and/or to the connecting elements 14′, 14″, or the antenna connections are themselves adhesively bonded to the connecting elements 14′, 14″, in particular by means of conductive adhesive, or the antenna connections are soldered or welded to the connecting elements 14′, 14″. It is also possible to use combinations of adhesive bonding, soldering and welding.

The semiconductor chip 13 is fitted to the connecting means 14 in a manner spaced apart laterally from the coil end sections 22, 22′.

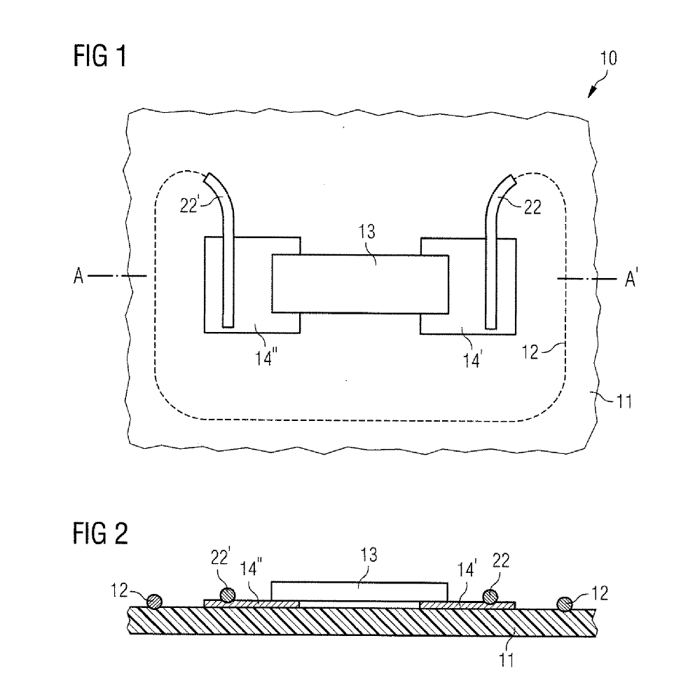

FIG. 2 shows the arrangement of the transponder 10 in a general form in cross section along the line A-A′ from FIG. 1.

The connecting elements 14′ and 14″ are arranged in a manner insulated from one another on the carrier substrate 11. The coil antenna 12 composed of wire is fitted to the carrier substrate 11 and the coil end sections 22, 22′ are fitted on the connecting elements 14′, 14″.

In addition, a semiconductor chip 13 is fitted on the connecting elements 14′, 14″, said semiconductor chip being electrically connected via antenna connections (not illustrated) at its surface to the connecting elements 14′, 14″ and thus also to the coil antenna 12.

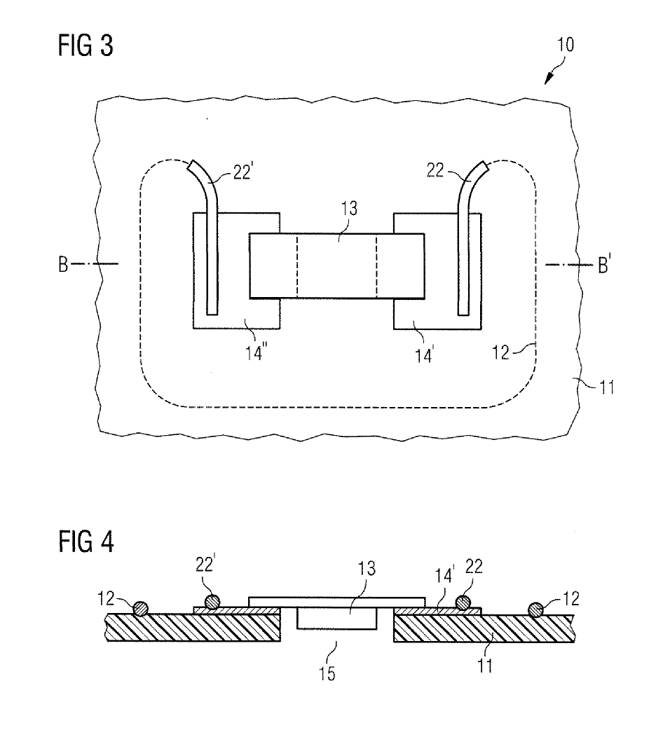

FIG. 3 shows a variation of the exemplary embodiment from FIG. 1, in which a chip module is used as semiconductor chip 13. The chip module comprises a chip and a carrier. The antenna connections (not illustrated) are fitted to the carrier, the chip and the antenna connections being electrically connected to one another via the carrier. The chip can be housed or unhoused.

FIG. 4 shows the cross section of the arrangements along the sectional line B-B′ from FIG. 3. In this case, the carrier substrate 11 has a cutout 15, in which at least one part of the semiconductor chip 13 can be accommodated. This makes the arrangement flatter. In FIG. 4, by way of example, the chip of the chip module projects into said cutout. The semiconductor chip 13, in this case the chip module, is electrically connected via antenna connections (not illustrated) at the carrier of the chip module to the connecting elements 14′, 14″ using flip-chip technology. Consequently, the chip module is also electrically connected to the antenna 12 via the coil end sections 22, 22′ at the connecting elements 14′, 14″.

FIG. 5 shows a further variation of the invention, in which the coil end sections 22, 22′ are made so thick that they project a height h higher above the carrier substrate surface 16 than the semiconductor chip 13. A protective function is thus achieved for the semiconductor chip 13.

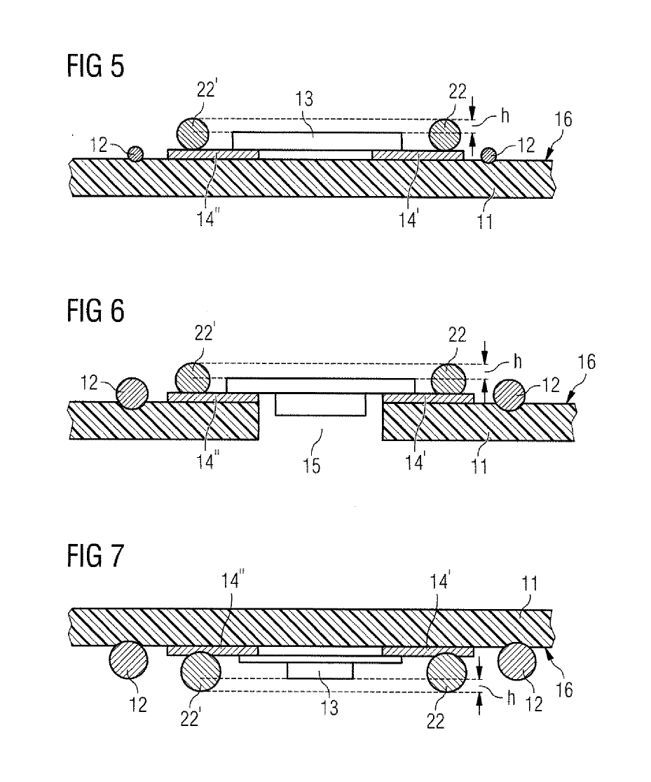

FIG. 6 shows an alternative embodiment with the protective function, wherein the coil end sections 22, 22′ project above a chip module by a height h. The chip module is partly arranged in a cutout 15 in order to reduce the thickness of the arrangement.

FIG. 7 shows an embodiment with maximal thickness, in which the coil end sections 22, 22′ project above the chip module by a height h, wherein the chip module is arranged completely above the surface 16 of the carrier substrate 11.

For the embodiments with protective function for the semiconductor chip 13 by means of the coil end sections 22, 22′ it is unimportant whether only the coil end sections 22, 22′ are produced with a corresponding thickness or whether the entire antenna is formed with this thickness.

1. A contactless transponder, comprising
a carrier substrate,
a coil antenna having two coil end sections,
a semiconductor chip having two antenna connections, and
two electrically conductive connecting elements, which are arranged in a manner electrically insulated from one another on the carrier substrate,
wherein the coil antenna is arranged on the carrier substrate and one coil end section is at least partly produced on the first connecting element and electrically connected thereto and the other coil end section is at least partly produced on the second connecting element and electrically connected thereto,
and wherein the first antenna connection of the semiconductor chip is fitted to the first connecting element and electrically connected thereto and the second antenna connection of the semiconductor chip is fitted to the second connecting element and electrically connected thereto.

2. The contactless transponder according to claim 1, wherein the carrier substrate has a cutout for receiving at least one part of the semiconductor chip.

3. The contactless transponder according to claim 1, wherein the carrier substrate is a thermoplastic material or paper.

4. The contactless transponder according to claim 1, wherein the coil antenna having the two coil end sections is formed from a wire.

5. The contactless transponder according to claim 4, wherein the wire is at least partly connected mechanically to the carrier substrate.

6. The contactless transponder according to claim 1, wherein the coil antenna having the two coil end sections is printed on.

7. The contactless transponder according to claim 1, wherein the coil antenna having the two coil end sections is produced electrolytically.

8. The contactless transponder according to claim 1, wherein the connecting elements are printed on the carrier substrate.

9. The contactless transponder according to claim 1, wherein the connecting elements are produced electrolytically on the carrier substrate.

10. The contactless transponder according to claim 1, wherein the connecting elements are prefabricated and connected to the carrier substrate in force-locking fashion.

11. The contactless transponder according to claim 1, wherein the coil end sections at least partly project a height h higher above the carrier substrate surface than the semiconductor chip.

12. A method for producing a contactless transponder comprising:
providing a carrier substrate, arranging two electrically conductive connecting elements on the carrier substrate in such a way that the connecting elements are electrically insulated from one another,
producing at least one part of a first coil end section on the first connecting element,
producing an electrical connection between the first coil end section and the first connecting element,
producing a coil antenna on the carrier substrate,
producing at least one part of a second coil end section on the second connecting element and producing an electrical connection between the second coil end section and the second connecting element, and
fitting a first antenna connection of a semiconductor chip to the first connecting element and a second antenna connection of the semiconductor chip to the second connecting element in such a way that an electrical connection is in each case produced between the semiconductor chip and the connecting element.

13. The method according to claim 12, wherein the two electrically conductive connecting elements are printed.

14. The method according to claim 12, wherein the two electrically conductive connecting elements are electrodeposited.

15. The method according to claim 12, wherein the two electrically conductive connecting elements are prefabricated and connected to the carrier substrate in force-locking fashion.

16. The method according to claim 12, wherein the coil antenna having the coil end sections is produced by laying a wire.

17. The method according to claim 12, wherein the coil end sections are welded to the connecting element at least at points.

18. The method according to claim 12, wherein the coil antenna having the two coil end sections is printed.

18. The method according to claim 12, wherein the coil antenna having the two coil end sections is electrodeposited.

20. The method according to claim 12, wherein the semiconductor chip is fitted using flip-chip technology and electrically connected to the connecting element.

21. The method according to claim 12, wherein the semiconductor chip is adhesively bonded on to the connecting element.

22. The method according to claim 12, wherein the semiconductor chip is soldered on to the connecting element.

23. The method according to claim 12, wherein the semiconductor chip is welded on to the connecting element.

24. A contactless transmission system comprising:
a carrier substrate,
an antenna on the carrier substrate,
a semiconductor chip,
a connecting means on the carrier substrate,
wherein the antenna and the semiconductor chip are fitted to the connecting means such that an electric current flow can take place between the antenna and the semiconductor chip.

25. A method for producing a contactless transmission system comprising:
providing a carrier substrate,
fitting a connecting means on the carrier substrate,
producing an antenna on the carrier substrate fitting the antenna to the connecting means, and
fitting a semiconductor chip to the connecting means.
